(19) United States
(12) Patent Application Publication
(10) Pub. No.: US 2008/0192106 A1
(43) Pub. Date: Aug. 14, 2008

(54) Image Generating Apparatus

(75) Inventors: Kunio SAWAI, Daito-shi (JP); Takahiro Naito, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/027,660

(22) Filed: Feb. 7, 2008

(30) Foreign Application Priority Data
Feb. 8, 2007 (JP) 2007-28677

(51) Int. Cl. G01D 15/10

(52) U.S. Cl. 347/197

(57) ABSTRACT

This image generating apparatus includes a chassis and a side plate, a cartridge stop member provided on a first side surface of the chassis integrally has a first shaft stop portion coming into contact with a first end surface of a shaft of a print head pressing member, and a side plate provided on a second side surface of the chassis integrally has a second shaft stop portion coming into contact with a second end surface of the shaft of the print head pressing member.

### BACKGROUND OF THE INVENTION

1. Field of the Invention

The present invention relates to an image generating apparatus.

2. Description of the Background Art

An image generating apparatus comprising various rotating shafts are known in general, as disclosed in each of Japanese Patent Laying-Open Nos. 2005-219310, 2004-114588, 2001-271826, 06-317975 (1994) and 08-225182 (1996), for example.

The aforementioned Japanese Patent Laying-Open No. 2005-219310 discloses a thermal transfer sheet cassette (ink sheet cartridge) comprising a columnar take-up core for taking up a thermal transfer sheet (ink sheet) and a take-up core holding portion. In the thermal transfer sheet cassette described in Japanese Patent Laying-Open No. 2005-219310, two cylindrical members are inserted into both ends of the take-up core, while a coil spring is set in the cylindrical member provided on one of the ends of the take-up core. The coil spring and the two cylindrical members keep the position of the take-up core.

The aforementioned Japanese Patent Laying-Open No. 2004-114588 discloses a thermal printer (image generating apparatus) comprising a thermal head for printing images on papers, a shaft (shaft portion) for rotatably mounting the thermal head on the printer body and a fixture for keeping the position of the shaft. In the thermal printer described in Japanese Patent Laying-Open No. 2004-114588, the shaft is inserted into axial holes provided on both ends of the thermal head respectively to pass through the same. At this time, the fixture is mounted from outside one of the axial holes of the thermal head to block up this axial hole, so that an end of the shaft passing through the axial holes comes into contact with the fixture. Thus, the fixture comes into contact with the shaft, thereby keeping the position of the shaft in the thermal head.

The aforementioned Japanese Patent Laying-Open No. 2001-271826 discloses an image generating apparatus comprising a paper feed support shaft including a paper feed roller for feeding recording sheets (printing papers) to the body of the apparatus and two bearing set portions including bearings for supporting the paper feed support shaft respectively. In the image generating apparatus described in Japanese Patent Laying-Open No. 2001-271826, the paper feed support shaft is inserted into holes provided in the bearings of the bearing set portions while two clasps are arranged on the paper feed support shaft to hold one of the bearings therebetween, thereby keeping the position of the paper feed support shaft on the bearing set portions.

The aforementioned Japanese Patent Laying-Open No. 06-317975 discloses an image generating apparatus comprising a roller shaft of metal, a slide bearing for rotatably supporting the roller shaft and a bearing slide guide pawl for holding the slide bearing. In the image generating apparatus described in Japanese Patent Laying-Open No. 06-317975, the slide bearing includes a hole for receiving the roller shaft, while the hole has a stopper for preventing the roller shaft from slipping off the hole. The bearing slide guide pawl formed on the body of the image generating apparatus holds the slide bearing, thereby fixing the same.

The aforementioned Japanese Patent Laying-Open No. 08-225182 discloses an image generating apparatus comprising a chassis so formed as to cover the body of the apparatus, a transport roller for transporting sheets (papers) to the body of the apparatus, two plastic bearings having holes and an L-shaped wire spring. In the image generating apparatus described in Japanese Patent Laying-Open No. 08-225182, the bearings are mounted by fitting both side ends of the transport roller into the holes of the bearings respectively, and thereafter fitting the portions of the bearings mounted on the transport roller into holes of the chassis. The center of the L-shaped wire spring is engaged with a groove provided in one of the bearings while both ends of the L-shaped wire spring are urged against the chassis respectively, thereby keeping the position of the transport roller on the chassis.

In the thermal transfer sheet cassette described in the aforementioned Japanese Patent Laying-Open No. 2005-219310, however, the coil spring and the two cylindrical members must be separately provided in order to keep the position of the take-up core, whereby the number of components is disadvantageously increased.

In the thermal printer described in the aforementioned Japanese Patent Laying-Open No. 2004-114588, the fixture must be separately provided in order to keep the position of the shaft, whereby the number of components is disadvantageously increased.

In the image generating apparatus described in the aforementioned Japanese Patent Laying-Open No. 2001-271826, the two clasps must be separately provided in order to keep the position of the paper feed support shaft, whereby the number of components is disadvantageously increased.

In the image generating apparatus described in the aforementioned Japanese Patent Laying-Open No. 06-317975, the slide bearing must be separated in order to support the roller shaft, whereby the number of components is disadvantageously increased.

In the image generating apparatus described in the aforementioned Japanese Patent Laying-Open No. 08-225182, the two bearings and the wire spring must be separately provided respectively in order to keep the position of the transport roller, whereby the number of components is disadvantageously increased.

### SUMMARY OF THE INVENTION

The present invention has been proposed in order to solve the aforementioned problems, and an object of the present invention is to provide an image generating apparatus capable of keeping the position of a shaft without increasing the number of components.

An image generating apparatus according to a first aspect of the present invention comprises a chassis detachably mounted with an ink sheet cartridge storing an ink sheet and integrally provided with a first bearing, a print head rotatably mounted on the chassis, a print head pressing member, including a shaft held by the first bearing, pressing the print head, a cartridge stop member provided on a first side surface of the chassis for engaging with the ink sheet cartridge thereby preventing the ink sheet cartridge from slipping off the chassis and a side plate, provided on a second side surface of the chassis, integrally including at least a second bearing of a paper feed roller, while the cartridge stop member provided on the first side surface of the chassis integrally includes a first shaft stop portion coming into contact with a first end surface of the shaft of the print head pressing member, and the side plate provided on the second side surface of the chassis integrally includes a second shaft stop portion coming into contact with a second end surface of the shaft of the print head pressing member.

In the image generating apparatus according to the first aspect, as hereinabove described, the first bearing is integrally provided on the chassis while the cartridge stop member integrally including the first shaft stop portion is provided on the first side surface of the chassis and the side plate integrally including the second shaft stop portion is provided on the second side surface of the chassis so that the first and second shaft stop portions for holding the shaft of the print head pressing member are integrally included in the cartridge stop member and the side plate respectively and the first bearing is integrally provided on the chassis, whereby no member may be separately provided for holding the shaft of the print head pressing member on the chassis. Therefore, increase in the number of components can be suppressed. Further, both end surfaces of the shaft of the print head pressing member are brought into contact with the first shaft stop portion of the cartridge stop member and the second shaft stop portion of the side plate respectively and supported by the first bearing of the chassis, whereby the shaft of the print head printing member can be held without newly providing a separate member.

In the aforementioned image generating apparatus according to the first aspect, the second shaft stop portion preferably includes a shaft pressing portion elastically deformable in a first direction intersecting with the axis of the shaft and pressed in the first direction by a peripheral surface of the shaft close to a second end thereof when the shaft is mounted on the first bearing of the chassis. According to this structure, the shaft can be easily mounted on the first bearing of the chassis by pressing the elastically deformable shaft pressing portion of the second shaft stop portion with the peripheral surface of the shaft close to the second end thereof.

In the aforementioned image generating apparatus according to the first aspect, the second shaft stop portion is preferably provided with a contact portion, coming into contact with the second end surface of the shaft, on a position separated from a side surface of the shaft pressing portion closer to the shaft by a prescribed length outwardly from the shaft to be continuous with the shaft pressing portion. According to this structure, the second end surface of the shaft can be brought into contact with the contact portion, whereby the shaft can be inhibited from slipping off the body of the image generating apparatus. Therefore, the position of the shaft can be reliably kept.

In the aforementioned image generating apparatus according to the first aspect, the thickness of the contact portion in the first direction intersecting with the axis of the shaft is preferably larger than the corresponding thickness of the second shaft stop portion. According to this structure, the contact area between the contact portion and the second end surface of the shaft of the print head pressing portion can be so increased that the shaft can be reliably inhibited from slipping off the first bearing.

In the aforementioned image generating apparatus according to the first aspect, the second shaft stop portion is preferably so formed that the width in the axial direction of the shaft is larger than the thickness in the direction intersecting with the axis of the shaft. According to this structure, the second shaft stop portion can be inhibited from deformation in the axial direction of the shaft, whereby the shaft can be inhibited from slipping off the first bearing in the axial direction. Consequently, the shaft can be reliably held.

In the aforementioned image generating apparatus according to the first aspect, the first bearing preferably includes an L-shaped notch having a vertically extending first portion and a second portion horizontally extending from the first portion, for holding the shaft in the vicinity of the forward end of the second portion of the L-shaped notch. According to this structure, the horizontally provided second portion regulates vertical movement of the shaft, whereby the shaft can be reliably held.

The aforementioned image generating apparatus according to the first aspect preferably further comprises a platen roller opposed to the print head and a heat radiating member mounted on the print head for radiating heat generated in the print head, while the heat radiating member is preferably integrally provided with a push-up portion pushed up by the print head pressing member upon rotation of the print head pressing member, and the print head pressing member preferably so pushes up the push-up portion of the heat radiating member upon rotation of the print head pressing member as to move the heat radiating member and the print head in a direction for separating from the platen roller. According to this structure, the print head pressing member pushes up the push-up portion by the rotational force upon rotation thereof, whereby the heat radiating member and the print head can be easily rotated in the direction for separating from the platen roller with no requirement for a transmission mechanism so provided as to transmit the rotational force of the print head pressing member to the heat radiating member and the print head. Consequently, increase in the number of components can be further suppressed.

In this case, the print head pressing member preferably presses the print head toward the platen roller in printing, and the heat radiating member preferably includes a deviation preventing portion preventing the print head pressing member from deviating in the rotational direction when the print head pressing member presses the print head toward the platen roller in printing. According to this structure, the print head pressing member does not deviate in the rotational direction in printing, thereby reliably pressing the print head toward the platen roller.

In the aforementioned image generating apparatus according to the first aspect, the body of the print head pressing member is preferably made of resin. According to this structure, noise caused in the print head pressing member when sliding with the shaft of metal upon rotation can be suppressed as compared with a case where the print head pressing member is made of metal.

An image generating apparatus according to a second aspect of the present invention comprises a chassis detachably mounted with an ink sheet cartridge storing an ink sheet, a print head rotatably mounted on the chassis, a first bearing, integrally provided on the chassis, constituted of an L-shaped notch, a print head pressing member, including a shaft held by the first bearing, pressing the print head, a cartridge stop member provided on a first side surface of the chassis for engaging with the ink sheet cartridge thereby preventing the ink sheet cartridge from slipping off the chassis and a side plate, provided on a second side surface of the chassis, integrally including at least a second bearing of a paper feed roller, while the cartridge stop member provided on the first side surface of the chassis integrally includes a first shaft stop portion coming into contact with a first end surface of the shaft of the print head pressing member, the side plate provided on the second side surface of the chassis integrally includes a second shaft stop portion coming into contact with a second end surface of the shaft of the print head pressing member, the second shaft stop portion includes a shaft pressing portion elastically deformable in a first direction intersecting with the axis of the shaft and pressed in the first direction by a peripheral surface of the shaft close to a second end thereof when the shaft is mounted on the first bearing of the chassis, the second shaft stop portion of the side plate further includes a contact portion provided on a position separated from a side surface of the shaft pressing portion closer to the shaft by a prescribed length outwardly from the shaft to be continuous with the shaft pressing portion for coming into contact with the second end surface of the shaft, and the thickness of the contact portion of the second shaft stop portion in the first direction intersecting with the axis of the shaft is larger than the corresponding thickness of the second shaft stop portion.

In the image generating apparatus according to the second aspect, as hereinabove described, the first bearing is integrally provided on the chassis while the cartridge stop member integrally including the first shaft stop portion is provided on the first side surface of the chassis and the side plate integrally including the second shaft stop portion is provided on the second side surface of the chassis so that the first and second shaft stop portions for holding the shaft of the print head pressing member are integrally included in the cartridge stop member and the side plate respectively and the first bearing is integrally provided on the chassis, whereby no member may be separately provided for holding the shaft of the print head pressing member on the chassis. Therefore, increase in the number of components can be suppressed. Further, both end surfaces of the shaft of the print head pressing member are brought into contact with the first shaft stop portion of the cartridge stop member and the second shaft stop portion of the side plate respectively and supported by the first bearing of the chassis, whereby the shaft of the print head printing member can be held without newly providing a separate member.

In the image generating apparatus according to the second aspect, further, the second shaft stop portion includes the shaft pressing portion elastically deformable in the first direction intersecting with the axis of the shaft and pressed in the first direction by the peripheral surface of the shaft close to the second end thereof when the shaft is mounted on the first bearing of the chassis, whereby the shaft can be easily mounted on the first bearing of the chassis by pressing the elastically deformable shaft pressing portion of the second shaft stop portion with the peripheral surface of the shaft close to the second end thereof. In addition, the second shaft stop portion is provided with the contact portion, coming into contact with the second surface of the shaft, on the position separated from the side surface of the shaft pressing portion closer to the shaft by the prescribed length outwardly from the shaft to be continuous with the shaft pressing portion so that the second end surface of the shaft can be brought into contact with the contact portion, whereby the shaft can be inhibited from slipping off the body of the image generating apparatus. Therefore, the position of the shaft can be reliably kept. Further, the thickness of the contact portion in the first direction intersecting with the axis of the shaft is larger than the corresponding thickness of the second shaft stop portion, whereby the contact area between the contact portion and the second end surface of the shaft of the print head pressing portion can be so increased that the shaft can be reliably inhibited from slipping off the first bearing.

In the aforementioned image generating apparatus according to the second aspect, the second shaft stop portion is preferably so formed that the width in the axial direction of the shaft is larger than the width in the first direction intersecting with the axis of the shaft. According to this structure, the second shaft stop portion can be inhibited from deformation in the axial direction of the shaft, whereby the shaft can be inhibited from slipping off the first bearing in the axial direction. Consequently, the shaft can be reliably held.

In the aforementioned image generating apparatus according to the second aspect, the first bearing preferably includes the L-shaped notch having a vertically extending first portion and a second portion horizontally extending from the first portion, for holding the shaft in the vicinity of the forward end of the second portion of the L-shaped notch. According to this structure, the horizontally provided second portion regulates vertical movement of the shaft, whereby the shaft can be reliably held.

The aforementioned image generating apparatus according to the second aspect preferably further comprises a platen roller opposed to the print head and a heat radiating member mounted on the print head for radiating heat generated in the print head, while the heat radiating member is preferably integrally provided with a push-up portion pushed up by the print head pressing member upon rotation of the print head pressing member, and the print head pressing member preferably so pushes up the push-up portion of the heat radiating member upon rotation of the print head pressing member as to move the heat radiating member and the print head in a direction for separating from the platen roller. According to this structure, the print head pressing member pushes up the push-up portion by the rotational force upon rotation thereof, whereby the heat radiating member and the print head can be easily rotated in the direction for separating from the platen roller with no requirement for a transmission mechanism so provided as to transmit the rotational force of the print head pressing member to the heat radiating member and the print head. Consequently, increase in the number of components can be further suppressed.

In this case, the print head pressing member preferably presses the print head toward the platen roller in printing, and the heat radiating member preferably includes a deviation preventing portion preventing the print head pressing member from deviating in the rotational direction when the print head pressing member presses the print head toward the platen roller in printing. According to this structure, the print head pressing member does not deviate in the rotational direction in printing, thereby reliably pressing the print head toward the platen roller.

In the aforementioned image generating apparatus according to the second aspect, the body of the print head pressing member is preferably made of resin. According to this structure, noise caused in the print head pressing member when sliding with the shaft of metal upon rotation can be suppressed as compared with a case where the print head pressing member is made of metal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a sublimatic printer according to a first embodiment of the present invention;

FIG. 2 is an exploded perspective view showing the overall structure of the sublimatic printer according to the first embodiment of the present invention shown in FIG. 1;

FIG. 3 is a perspective view of the sublimatic printer according to the first embodiment of the present invention shown in FIG. 1;

FIG. 4 is a plan view of the sublimatic printer according to the first embodiment of the present invention shown in FIG. 1;

FIG. 5 is a sectional view of the sublimatic printer according to the first embodiment of the present invention shown in FIG. 1;

FIG. 6 illustrates the arrangement of gears in the sublimatic printer according to the first embodiment of the present invention shown in FIG. 1;

FIG. 7 is an enlarged perspective view showing a side plate mounted on a first side surface of the sublimatic printer according to the first embodiment of the present invention shown in FIG. 1;

FIGS. 8 and 9 are entire perspective views of the side plate mounted on the first side surface of the sublimatic printer according to the first embodiment of the present invention shown in FIG. 1;

FIG. 10 is an entire perspective view showing another side plate mounted on a second side surface of the sublimatic printer according to the first embodiment of the present invention shown in FIG. 1;

FIG. 11 is a plan view showing a second shaft stop portion provided on the side plate shown in FIG. 10;

FIG. 12 is a side elevational view showing the second shaft stop portion provided on the side plate shown in FIG. 10;

FIG. 13 is a perspective view of a print head pressing member mounted on the sublimatic printer according to the first embodiment of the present invention shown in FIG. 1;

FIG. 14 is an exploded perspective view of the print head pressing member mounted on the sublimatic printer according to the first embodiment of the present invention shown in FIG. 1;

FIG. 15 is a perspective view for illustrating a method of mounting the print head pressing member on the sublimatic printer according to the first embodiment of the present invention shown in FIG. 1;

FIG. 16 is a sectional view for illustrating the method of mounting the print head pressing member on the sublimatic printer according to the first embodiment of the present invention shown in FIG. 1;

FIG. 17 is a perspective view for illustrating the method of mounting the print head pressing member on the sublimatic printer according to the first embodiment of the present invention shown in FIG. 1;

FIG. 18 is a sectional view for illustrating the method of mounting the print head pressing member on the sublimatic printer according to the first embodiment of the present invention shown in FIG. 1;

FIG. 19 is a perspective view for illustrating the method of mounting the print head pressing member on the sublimatic printer according to the first embodiment of the present invention shown in FIG. 1;

FIG. 20 is a sectional view for illustrating the method of mounting the print head pressing member on the sublimatic printer according to the first embodiment of the present invention shown in FIG. 1;

FIGS. 21 and 22 are perspective views for illustrating the method of mounting the print head pressing member on the sublimatic printer according to the first embodiment of the present invention shown in FIG. 1;

FIG. 23 is a diagram for illustrating an operation of the sublimatic printer according to the first embodiment of the present invention shown in FIG. 1;

FIG. 24 is a perspective view showing the overall structure of a sublimatic printer according to a second embodiment of the present invention;

FIGS. 25 and 26 are perspective views for illustrating a print head pressing member of the sublimatic printer according to the second embodiment of the present invention shown in FIG. 24; and

FIGS. 27 to 29 are sectional views of the sublimatic printer according to the second embodiment of the present invention shown in FIG. 24.

### DESCRIPTION OF THE PREFERRED EMBODIMENTS

Embodiments of the present invention are now described with reference to the drawings.

### First Embodiment

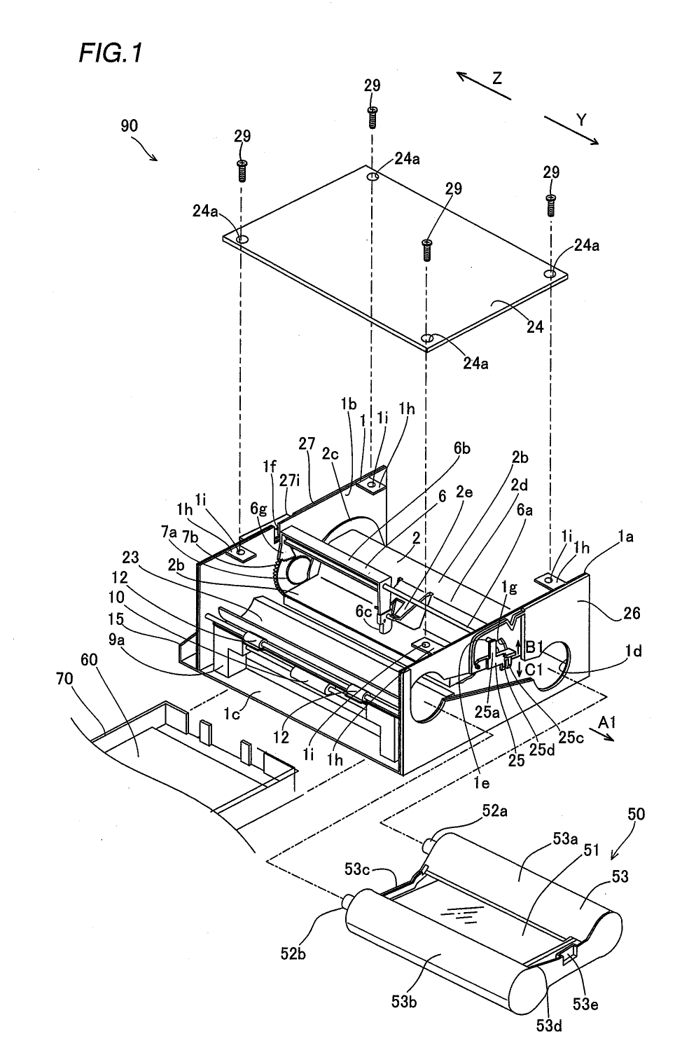

First, the structure of a sublimatic printer 90 according to a first embodiment of the present invention is described with reference to FIGS. 1 to 22. According to the first embodiment, the present invention is applied to the sublimatic printer 90 employed as an exemplary image generating apparatus.

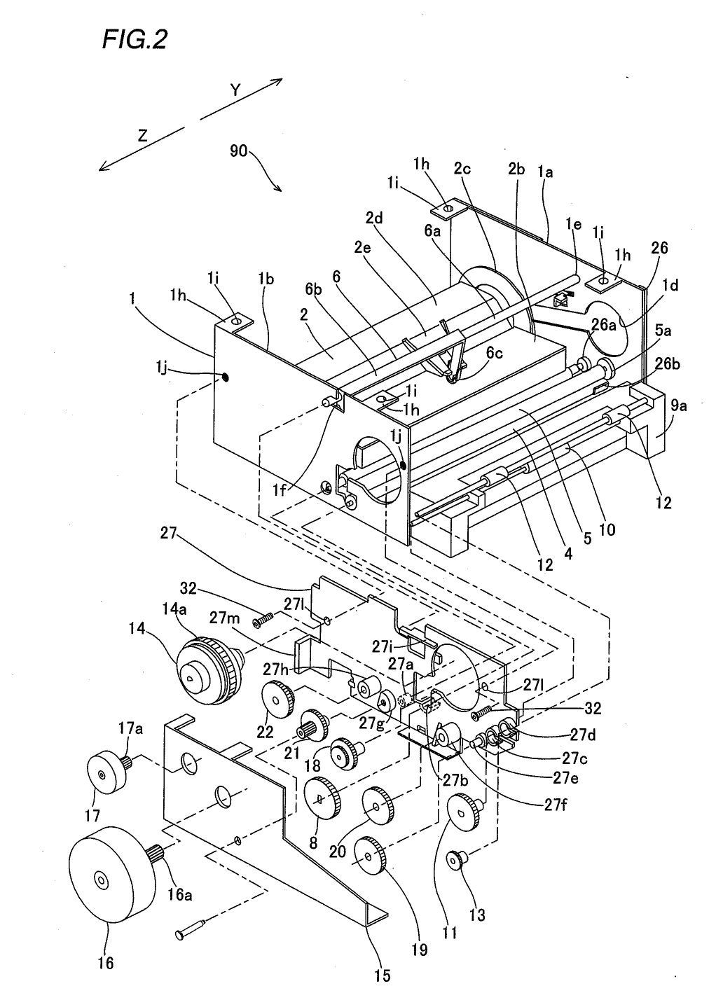

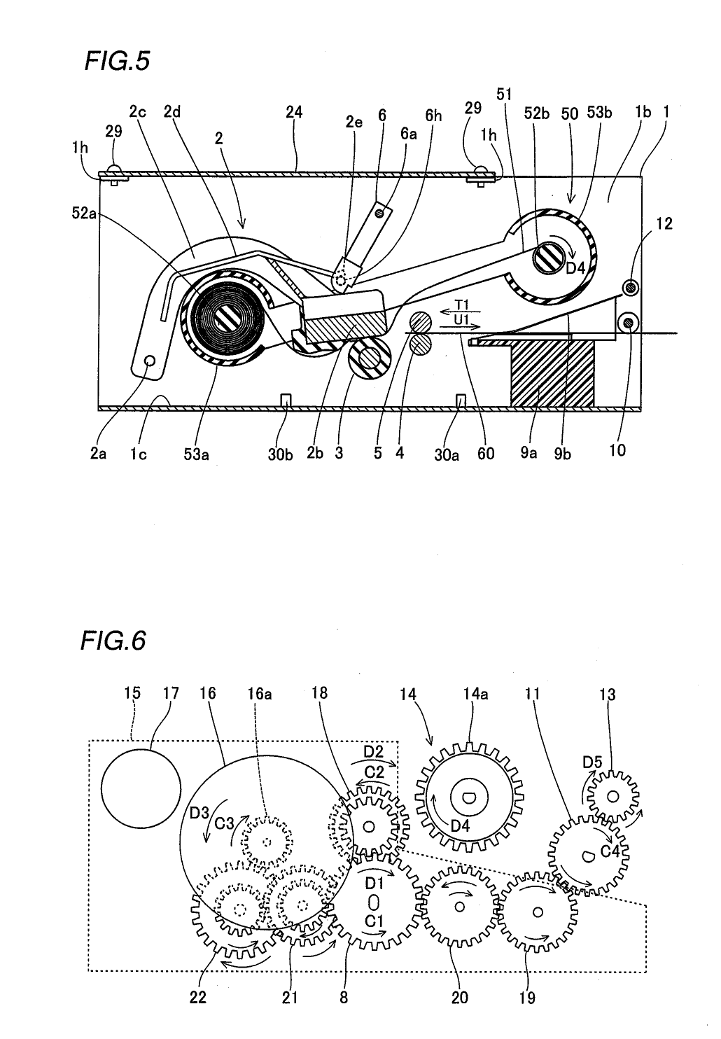

As shown in FIG. 1, the sublimatic printer 90 according to the first embodiment of the present invention comprises a chassis 1 of metal (sheet metal), a print head 2 for printing images, a platen roller 3 (see FIG. 5) opposed to the print head 2, a feed roller 4 (see FIG. 5) of metal, a press roller 5 (see FIG. 5) of metal pressing the feed roller 4 with prescribed pressing force, a print head pressing member 6, including a shaft 6a, pressing the print head 2, a driving gear 7 (see FIG. 4) of resin constituted of a small-diametral gear 7a and a large-diametral gear 7b, a feed roller gear 8 (see FIGS. 2 and 6), a lower paper guide 9a of resin, an upper paper guide 9b (see FIG. 5) of resin, a paper feed roller 10 of rubber, a paper feed roller gear 11 (see FIGS. 2 and 6), a paper discharge roller 12 of rubber, a paper discharge roller gear 13 (see FIGS. 2 and 6) and a take-up reel 14 (see FIG. 2).

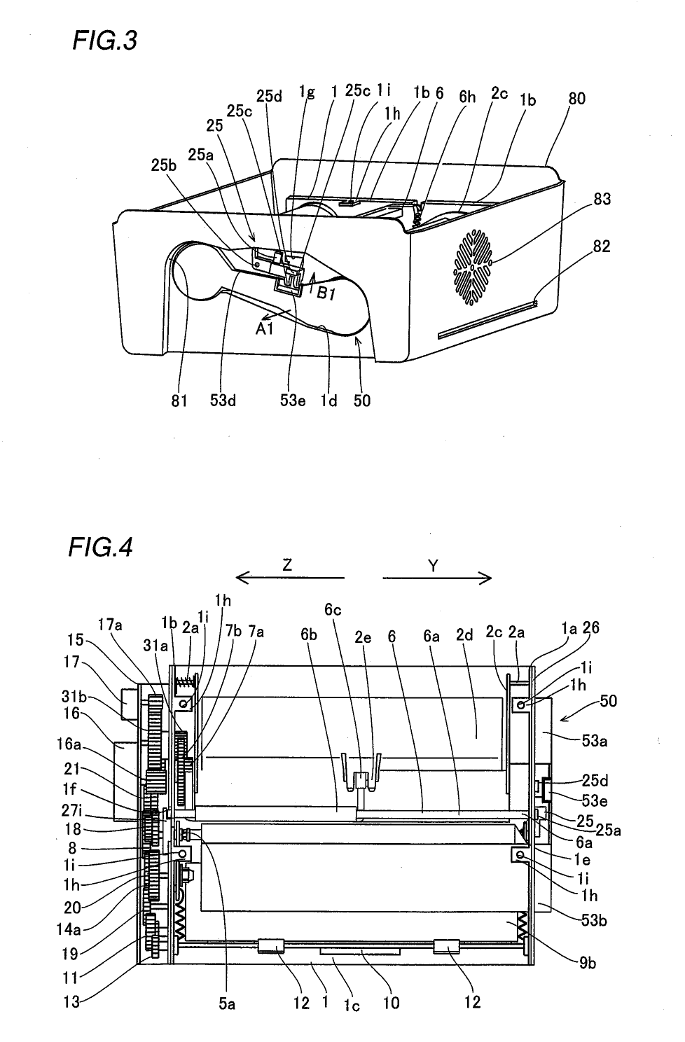

The sublimatic printer 90 further comprises a motor bracket 15 (see FIG. 2) of sheet metal, a stepping motor 16 (see FIG. 2) for transporting papers 60, another stepping motor 17 (see FIG. 2) serving as the driving source for rotating the print head 2, a swingable swing gear 18 (see FIGS. 2 and 6), a plurality of intermediate gears 19 to 22 (see FIGS. 2 and 6), a cartridge support portion 23 supporting an ink sheet cartridge 50 storing an ink sheet 51, a top plate 24 and a housing 80 (see FIG. 3) storing the chassis 1 therein. The ink sheet cartridge 50 and a paper feed cassette case 70 for storing the papers 60 supplied to the sublimatic printer 90 are detachably mounted on the sublimatic printer 90 according to the first embodiment.

As shown in FIG. 1, the chassis 1 has a first side surface 1a and a second side surface 1b opposed to each other and a bottom surface 1c. The first side surface 1a of the chassis 1 is provided with a cartridge receiving hole 1d for receiving the ink sheet cartridge 50 and a support hole 1e (see FIG. 2) supporting a first end of the shaft 6a of the print head pressing member 6.

According to the first embodiment, the second side surface 1b of the chassis 1 is integrally provided with an L-shaped bearing if formed by notching the second side surface 1b in an L-shaped manner, in order to support a second end (along arrow Z in FIG. 2) of the shaft 6a of the print head pressing member 6, as shown in FIG. 2. The L-shaped bearing if is constituted of a vertical portion extending in the vertical direction (along arrow X1) and a horizontal portion extending in the horizontal direction (perpendicular to the direction along arrow X1). The L-shaped bearing 1f is an example of the “first bearing” in the present invention.

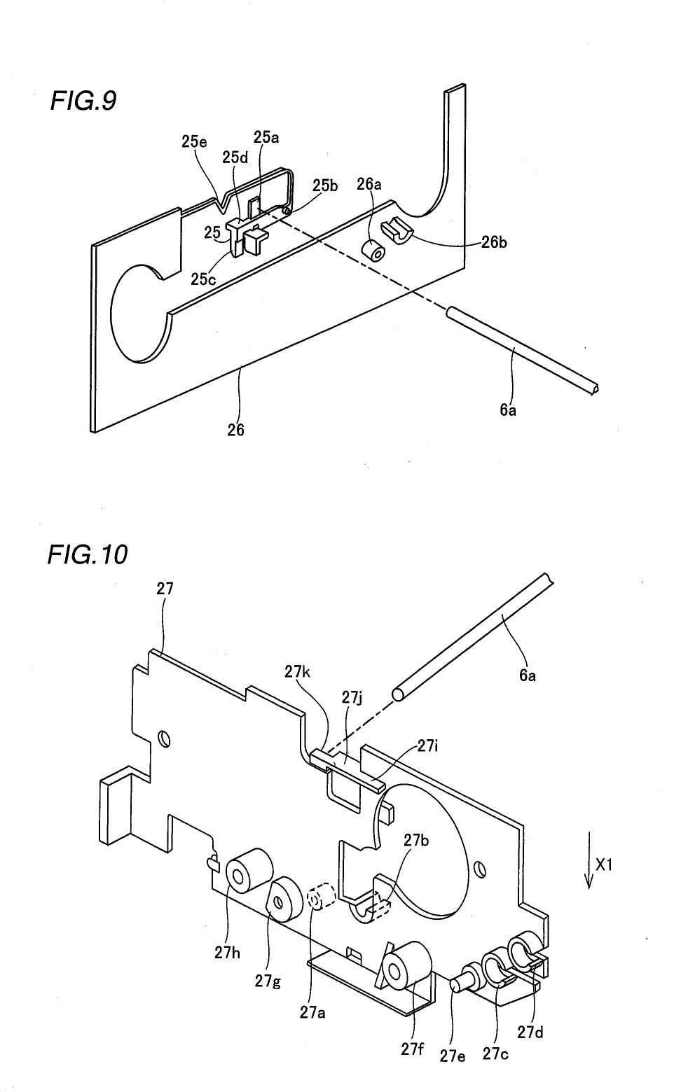

According to the first embodiment, a side plate 26 of resin integrally provided with a cartridge stop member 25 (see FIGS. 1 and 3) engaging with the ink sheet cartridge 50 thereby preventing the ink sheet cartridge 50 from slipping off the chassis 1 is mounted on the first side surface 1a of the chassis 1, as shown in FIG. 1. The side plate 26 is further integrally provided with a platen roller bearing 26a and a feed roller bearing 26b (see FIGS. 8 and 9) extending toward the inner side of the chassis 1 respectively, for supporting first ends (along arrow Y in FIG. 2) of the platen roller 3 and the feed roller 4 through holes (not shown) provided in the chassis 1 respectively, as shown in FIG. 2. Another side plate 27 of resin integrally including a platen roller bearing 27a supporting a second end (along arrow Z in FIG. 2) of the platen roller 3, a feed roller bearing 27b supporting the feed roller 4, a paper feed roller gear bearing 27c supporting the paper feed roller gear 11, a paper discharge roller gear bearing 27d supporting the paper discharge roller gear 13 and intermediate gear bearings 27e to 27h supporting the intermediate gears 19 to 22 respectively is mounted on the second side surface 1b of the chassis 1.

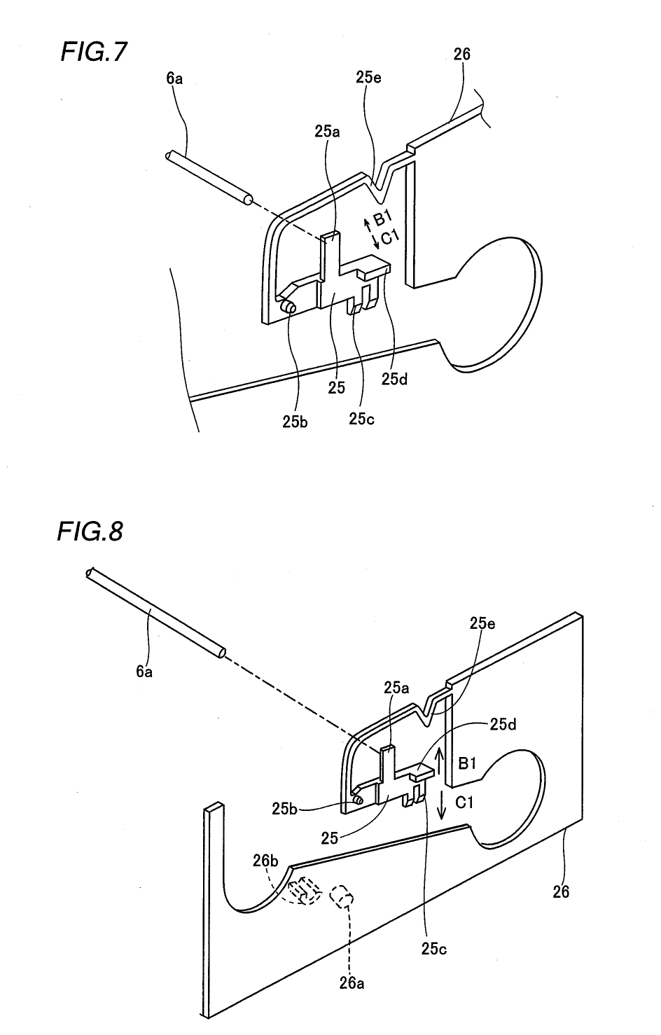

According to the first embodiment, the cartridge stop member 25 integrally provided on the side plate 26 mounted on the first side surface 1a of the chassis 1 integrally includes a first shaft stop portion 25a coming into contact with a first end surface of the shaft 6a of the print head pressing member 6, as shown in FIGS. 7 to 9.

According to the first embodiment, the side plate 27 integrally provided with the platen roller bearing 27a supporting the second end of the platen roller 3 and the like integrally includes a second shaft stop portion 27i, as shown in FIGS. 2 and 10.

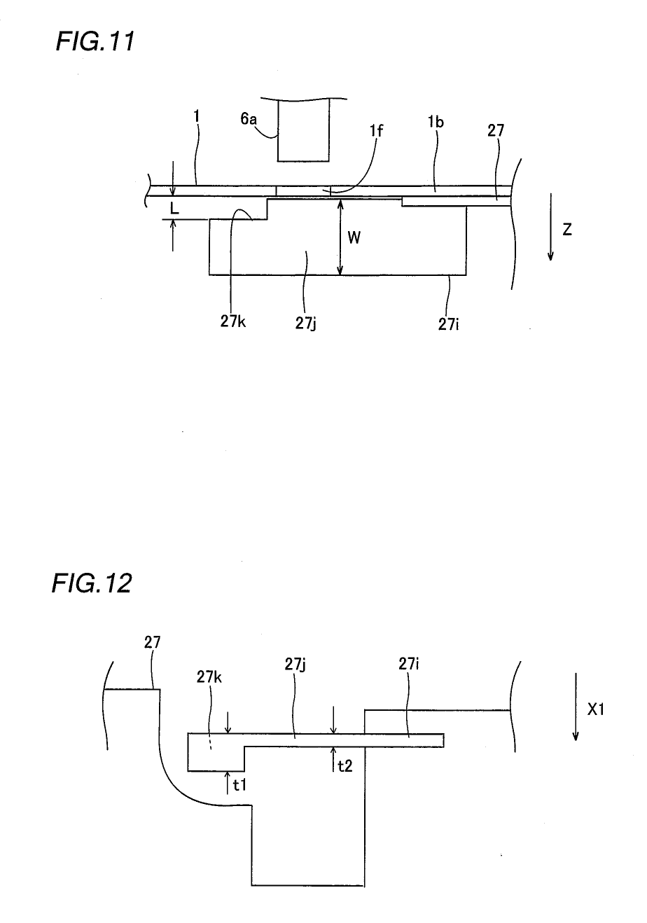

According to the first embodiment, the second shaft stop portion 27i of the side plate 27 includes a shaft pressing portion 27j and a contact portion 27k, as shown in FIGS. 10 and 11. The shaft pressing portion 27j of the second shaft stop portion 27i is elastically deformable in a direction (along arrow X1 in FIG. 10) perpendicular to the shaft 6a of the print head pressing member 6, and pressed by a peripheral surface of the shaft 6a of the print head pressing member 6 close to the second end (along arrow Z in FIG. 2) thereof along arrow X1 when the shaft 6a is mounted on the L-shaped bearing 1f of the chassis 1. The contact portion 27k of the second shaft stop portion 27i is provided on a position separated from the side of the shaft pressing portion 27j closer to the shaft 6a of the print head pressing member 6 by a prescribed length (length L in FIG. 11) outward from the shaft 6a to be continuous with the shaft pressing portion 27j as shown in FIG. 11, to come into contact with a second end surface of the shaft 6a.

According to the first embodiment, the thickness t1 of the contact portion 27k of the second shaft stop portion 27i in a direction (along arrow X1) intersecting with the axis of the shaft 6a of the print head pressing member 6 is larger than the corresponding thickness t2 of the second shaft stop portion 27i, as shown in FIG. 12. The second shaft stop portion 27i is so formed that the width W in the axial direction (along arrow Z) of the shaft 6a is larger than the thicknesses (t1 and t2 in FIG. 12) along arrow X1 as shown in FIG. 11, to be hardly elastically deformable in the axial direction (along arrow Z) of the shaft 6a.

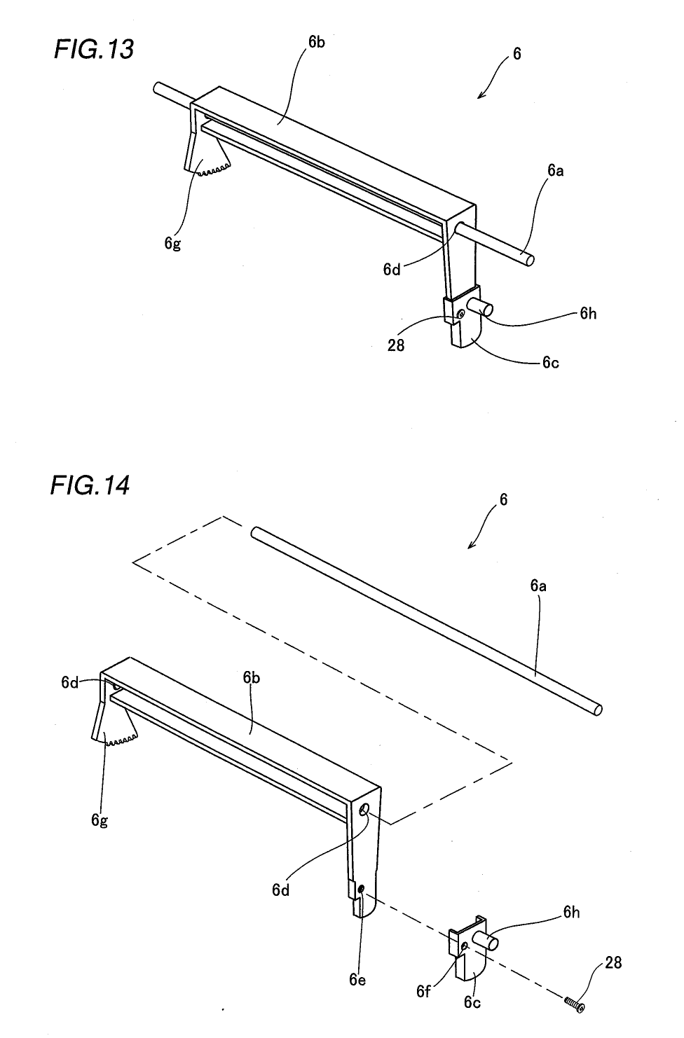

As shown in FIGS. 13 and 14, the print head pressing member 6 mounted on the chassis 1 is constituted of the shaft 6a of metal, a rotational portion 6b of metal and a pressing portion 6c of resin. The rotational portion 6b of metal is formed by performing sheet metal working on a plate member, and provided with receiving holes 6d for receiving the shaft 6a on both ends thereof respectively. A threaded hole 6e for mounting the pressing portion 6c with a screw 28 is provided on the side of the rotational portion 6b opposed to the first side surface 1a of the chassis 1. The pressing portion 6c is fixed to the rotational portion 6b by meshing the screw 28 with the threaded hole 6e of the rotational portion 6b through another threaded hole 6f of the pressing portion 6c. A gear portion 6g is provided on the side opposed to the second side surface 1b of the chassis 1. The pressing portion 6c is provided with a boss-shaped engaging portion 6h engaging with a notch 2e of the print head 2 described later in a projecting manner.

As shown in FIGS. 4 and 7 to 9, the cartridge stop member 25 integrally provided on the side plate 26 is provided with the aforementioned first shaft stop portion 25a, a support shaft 25b rotatably supporting the cartridge stop member 25, an engaging pawl 25c engaging with an engaging portion 53e (see FIGS. 1 and 3) of the ink sheet cartridge 50 described later, a grasp portion 25d employed by the user for lifting the cartridge stop member 25 upward (along arrow B1 in FIG. 7) with his/her finger and a spring portion 25e applying urging force for rotating the engaging pawl 25c of the cartridge stop member 25 downward (along arrow C1 in FIG. 7) when the user lifts up the grasp portion 25d. When the user lifts up the grasp portion 25d of the cartridge stop member 25, the cartridge stop member 25 slides upward along a hole 1g (see FIGS. 1 and 3) of the first side surface 1a of the chassis 1. When the cartridge stop member 25 slides upward, the cartridge stop member 25 is released from the state engaging with the ink sheet cartridge 50, so that the ink sheet cartridge 50 can be drawn out in a take-out direction (along arrow A1 in FIG. 1).

As shown in FIG. 1, two pairs of mounting portions 1h for mounting the top plate 24 are formed on the upper ends of the first and second side surfaces 1a and 1b of the chassis 1 respectively. The four mounting portions 1h of the chassis 1 are provided with threaded holes 1i for fixing the top plate 24 to the chassis 1 with screws 29 inserted into four holes 24a provided in the top plate 24 respectively. Paper sensors 30a and 30b for detecting front and rear ends of each paper 60 in printing are provided on the bottom surface 1c of the chassis 1, as shown in FIG. 5.

As shown in FIG. 2, the feed roller bearings 26b and 27b integrally provided on the side plates 26 and 27 respectively rotatably support the platen roller 3 and the feed roller 4. The feed roller bearing 26b of the side plate 26 supports the feed roller 4 through a hole (not shown) of the chassis 1, similarly to the platen roller bearing 26a. A press roller bearing 5a rotatably supports the press roller 5. The feed roller 4 and the press roller rotate while holding each paper 60 therebetween, thereby transporting the paper 60 in a paper feed direction (along arrow T1) or a paper discharge direction (along arrow U1), as shown in FIG. 5. The paper feed roller 10 transports the papers 60 stored in the paper feed cassette case 70 (see FIG. 1) into the chassis 1.

As shown in FIG. 5, the print head 2 includes a pair of support shafts 2a, a head portion 2b opposed to the platen roller 3 (see FIG. 2), a pair of arm portions 2c coupling the support shafts 2a and the head portion 2b with each other and a heat radiating member 2d of aluminum for radiating heat generated in the head portion 2b, and is vertically rotatable around the support shafts 2a mounted on the inner sides of the first and second side surfaces 1a and 1b of the chassis 1 respectively. The notch 2e engaging with the engaging portion 6h (see FIGS. 13 and 14) of the print head pressing member 6 is integrally formed on the central portion of the heat radiating member 2d by uprighting. When the print head pressing member 6 is rotated upward, therefore, the engaging portion 6h of the print head pressing member 6 and the notch 2e of the print head 2 engage with each other, whereby the head portion 2b is also rotated upward and the head portion 2b pressed by the platen roller 3 is separated from the platen roller 3.

As shown in FIGS. 2 and 4, the driving gear 7 constituted of the small-diametral gear 7a and the large-diametral gear 7b and the intermediate gear 31 constituted of a small-diametral gear 31a and a large-diametral gear 31b are so provided as to rotate the pressing portion 6c by transmitting the driving force of the stepping motor 17 to the pressing portion 6c of the print head pressing member 6. The driving gear 7 is mounted on the inner side of the second side surface 1b of the chassis 1. The intermediate gear 31 and the stepping motor 17 are mounted on the outer side of the second side surface 1b of the chassis 1 through the motor bracket 15. The small- and large-diametral portions 7a and 7b of the driving gear 7 mesh with the gear portion 6g (see FIGS. 13 and 14) of the print head pressing member 6 and the small-diametral gear 31a of the intermediate gear 31 respectively. The large-diametral gear portion 7b of the driving gear 7 meshes with a motor gear 17a of the stepping motor 17. Thus, the driving force of the stepping motor 17 is transmitted to the pressing portion 6c via the rotational portion 6b through the intermediate gear 31 and the driving gear 7.

As shown in FIG. 2, the side plate 27 is fixed by clamping two screws 32 into threaded holes 1j provided in the second side surface 1b of the chassis 1 through two holes 27l provided in the side plate 27, as shown in FIG. 2. The side plate 27 integrally includes a positioning portion 27m for positioning the motor bracket 15 mounted thereon.

As shown in FIG. 2, a motor gear 16a is mounted on the shaft of the stepping motor 16 mounted on the motor bracket 15. The stepping motor 16 functions as a driving source for driving a gear portion 14a of the take-up reel 14, the paper feed roller gear 11, the paper discharge roller gear 13 and the feed roller gear 8, as shown in FIG. 6.

The take-up reel 14 engages with a take-up bobbin 52b (see FIG. 1) arranged in a take-up bobbin storage portion 53b of the ink sheet cartridge 50 described later, thereby taking up the ink sheet 51 wound on the take-up bobbin 52b. The gear portion 14a of the take-up reel 14 meshes with the swing gear 18 upon swinging thereof, as shown in FIG. 6.

The lower paper guide 9a is set in the vicinity of the feed roller 4 and the press roller 5, as shown in FIG. 5. The upper paper guide 9b is mounted on the upper portion of the lower paper guide 9a. The upper paper guide 9b has a function of guiding each paper 60 to a paper feed path to a printing portion through the lower surface thereof in paper feeding while guiding each paper 60 to a paper discharge path through the upper surface thereof in paper discharge.

As shown in FIG. 3, the housing 80 includes a paper feed cassette receiving portion (not shown) receiving the paper feed cassette case 70 (see FIG. 1), a receiving hole 81 for receiving the ink sheet cartridge 50, a slot 82 passing each paper 60 therethrough in a reciprocative manner in printing and a heat discharge hole 83 for discharging heat generated in the print head 2 from the sublimatic printer 90.

As shown in FIG. 1, the ink sheet cartridge 50 includes a supply bobbin 52a for supplying the ink sheet 51 and the take-up bobbin 52b for taking up the supplied ink sheet 51. A cartridge case 53 constituting the ink sheet cartridge 50 is constituted of a supply bobbin storage portion 53a rotatably storing the supply bobbin 52a, the take-up bobbin storage portion 53b rotatably storing the take-up bobbin 52b and a pair of coupling portions 53c and 53d coupling the supply bobbin storage portion 53a and the take-up bobbin storage portion 53b with each other at a prescribed distance. When the supply bobbin storage portion 53a and the take-up bobbin storage portion 53b store the supply bobbin 52a and the take-up bobbin 52b respectively, therefore, the ink sheet 51 wound on the supply bobbin 52a and the take-up bobbin 52b is exposed on the space of the prescribed distance between the supply bobbin storage portion 53a and the take-up bobbin storage portion 53b. The coupling portion 53d is provided with the engaging portion 53e engaging with the cartridge stop member 25 (see FIGS. 1 and 3) of the side plate 26 provided on the first side surface 1a of the chassis 1. Helical compression springs (not shown) are provided in the supply bobbin storage portion 53a and the take-up bobbin storage portion 53b of the ink sheet cartridge 50 respectively. These helical compression springs regularly urge the ink sheet cartridge 50 mounted on the sublimatic printer 90 in the take-up direction (along arrow A1 in FIG. 1) for the ink sheet cartridge 50.

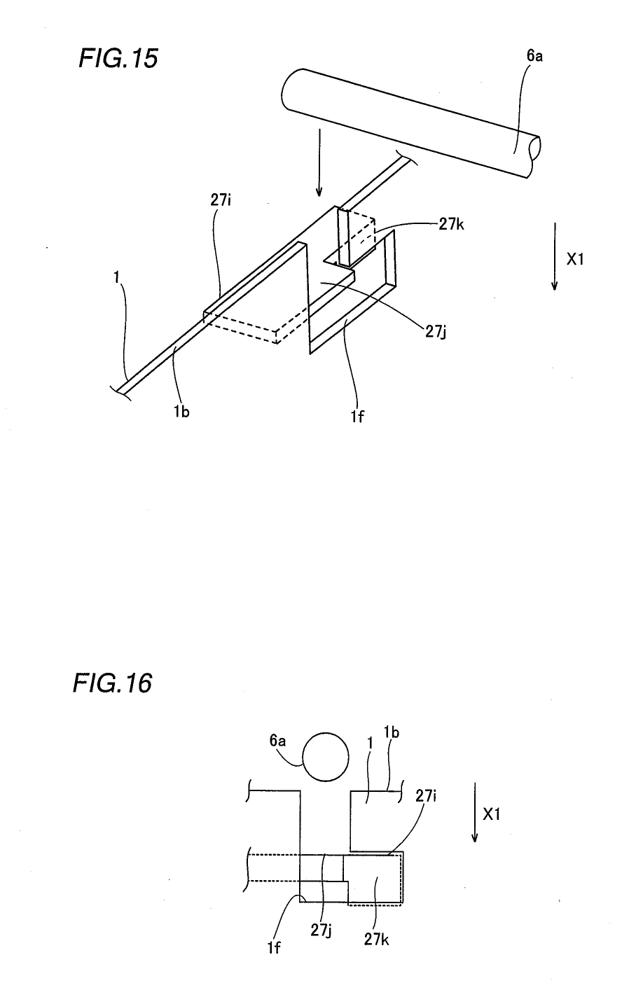

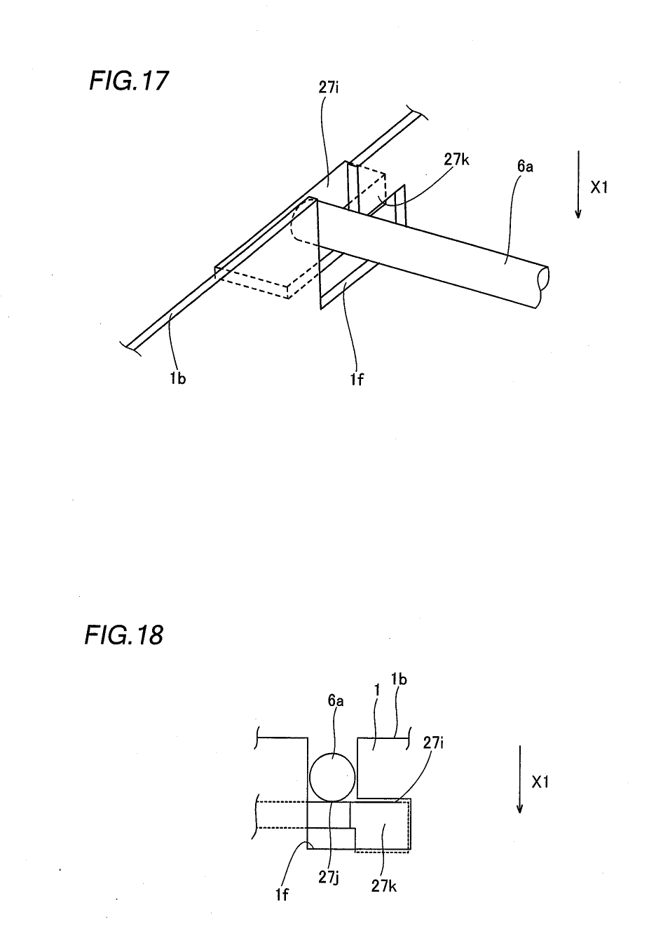

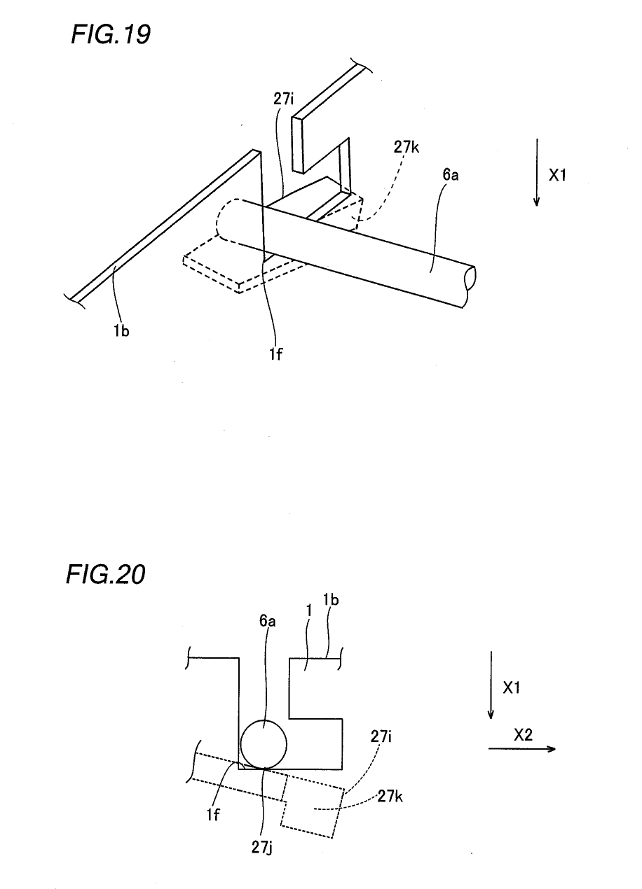

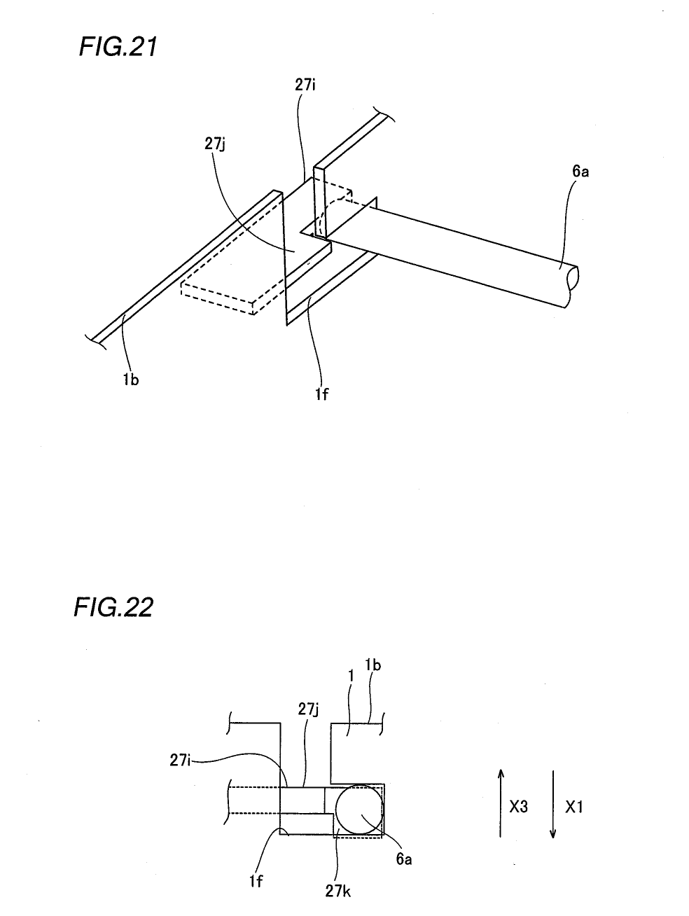

A method of mounting the print head pressing member 6 on the chassis 1 is now described. First, the first end (along arrow Y) of the shaft 6a of the print head pressing member 6 is inserted into the support hole 1e of the chassis 1, as shown in FIG. 2. At this time, the shaft 6a comes into contact with the first shaft stop portion 25a provided on the cartridge stop member 25 of the side plate 26 through the support hole 1e of the chassis 1 so that movement along arrow Y (see FIG. 4) is regulated, as shown in FIGS. 4 and 7 to 9. Therefore, the shaft 6a is inhibited from slipping off the chassis 1 along arrow Y. Then, the second end (along arrow Z in FIG. 2) of the shaft 6a is inserted along arrow X1 (vertical direction) with respect to the L-shaped bearing if of the chassis 1, as shown in FIGS. 15 and 16. At this time, the shaft 6a inserted along arrow X comes into contact with the shaft pressing portion 27j of the second shaft stop portion 27i provided on the side plate 27 without reaching the L-shaped bearing if, as shown in FIGS. 17 and 18. When the shaft 6a presses the shaft pressing portion 27j along arrow X1, the second shaft stop portion 27i is so deflected along arrow X1 that the shaft 6a reaches the bottom (horizontal portion) of the L-shaped bearing if, as shown in FIGS. 19 and 20. In this state, the shaft 6a so slides along arrow X2 as to reach a position (close to the forward end of the horizontal portion) of the L-shaped bearing if for holding the shaft 6a while the second shaft stop portion 27i is released from the pressing force of the shaft 6a along arrow X1, to be restored from the deflected state by restoring force along arrow X3, as shown in FIGS. 21 and 22. At this time, the second end (along arrow Z in FIG. 2) of the shaft 6a comes into contact with the contact portion 27k of the restored second shaft stop portion 27i so that movement along arrow Z (see FIG. 2) is regulated, as shown in FIG. 22. Thus, the shaft portion 6a is inhibited from slipping off the chassis 1 along arrow Z (see FIG. 2). Thus, the shaft 6a is supported by the support hole 1e and the L-shaped bearing 1f (see FIG. 1) of the chassis 1 and inhibited from slipping off the chassis 1 and the side plates 26 and 27 by the first shaft stop portion 25a and the contact portion 27k (see FIGS. 9 and 10) of the second shaft stop portion 27i, to be kept at the proper position.

A printing operation of the sublimatic printer 90 according to the first embodiment of the present invention is now described with reference to FIGS. 6 and 20.

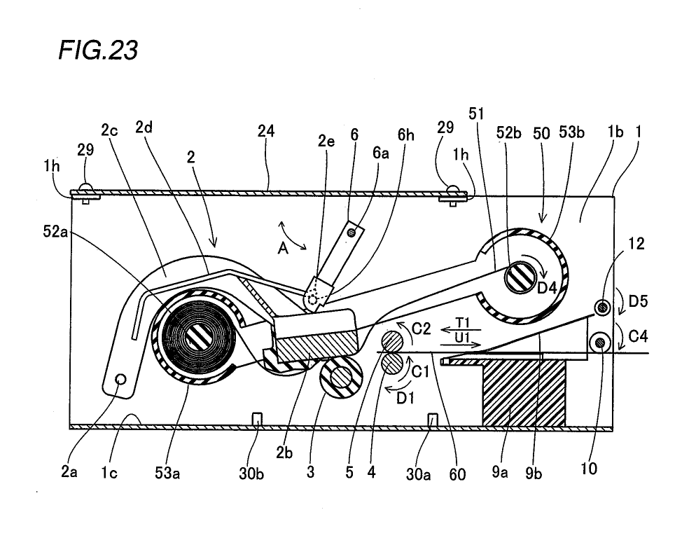

First, the stepping motor 16 is so driven as to rotate the motor gear 16a mounted thereon along arrow C3 and to rotate the feed roller gear 8 along arrow C1 through the intermediate gears 21 and 22, as shown in FIG. 6. Thus, the feed roller 4 is rotated along arrow C1 in FIG. 6. Further, the paper feed roller gear 11 and the paper feed roller 10 are rotated along arrow C4 in FIG. 23 through the intermediate gears 19 and 20. Thus, each paper 60 is transported in the paper feed direction (along arrow T1 in FIG. 23). At this time, the swingable swing gear 18 and the gear portion 14a of the take-up reel 14 are out of mesh, and the gear portion 14a of the take-up reel 14 remains unrotated. Thus, the ink sheet 51 wound on the supply bobbin 52a and the take-up bobbin 52b is not taken up in paper feeding.

As shown in FIG. 23, the paper sensors 30a and 30b detect the front and rear ends of the paper 60 respectively, thereby determining whether or not the paper 60 has been transported to a printing start position. When the paper 60 reaches the printing start position, the print head 2 lowers to the printing position and starts printing.

As shown in FIG. 23, further, the stepping motor 16 (see FIG. 6) is so driven as to rotate the motor gear 16a mounted thereon along arrow D3 in FIG. 6 and to rotate the feed roller gear 8 along arrow D1 in FIG. 6 through the intermediate gears 21 and 22. Thus, the feed roller 4 is rotated along arrow D1 in FIG. 23, and the press roller 5 is rotated along arrow B in FIG. 23 following the rotation of the feed roller 4. Further, the paper discharge roller gear 13 and the paper discharge roller 12 are rotated along arrow D5 in FIGS. 6 and 23 through the intermediate gears 19 and 20 and the paper feed roller 10. Thus, the paper 60 is transported in the paper discharge direction (along arrow U1 in FIG. 23) corresponding to the printing direction. At this time, the swingable swing gear 18 (see FIG. 6) meshes with the gear portion 14a of the take-up reel 14, so that the ink sheet 51 wound on the supply bobbin 52a and the take-up bobbin 52b engaging with the take-up reel 14 is taken up on the take-up bobbin 52b.

After the paper 60 is printed, the printed paper 60 is discharged. At this time, the printed paper 60 is transported along arrow U1 in FIG. 23, similarly to the operation for printing images on the paper 60. The printed paper 60 is transported on the upper side of the upper paper guide 9b, and discharged by the paper discharge roller 12 rotated along arrow D5 in FIG. 23.

According to the first embodiment, as hereinabove described, the chassis 1 is integrally provided with the first bearing if while the cartridge stop member 25 integrally including the first shaft stop portion 25a is provided on the first side surface 1a of the chassis 1 and the side plate 27 integrally including the second shaft stop portion 27i is provided on the second side surface 1b of the chassis 1 so that the first and second shaft stop portions 25a and 27i for holding the shaft 6a of the print head pressing member 6 are integrally included in the cartridge stop member 25 and the side plate 27 respectively and the first bearing 1f is integrally provided on the chassis 1, whereby no member may be separately provided for holding the shaft 6a of the print head pressing member 6 on the chassis 1. Therefore, increase in the number of components can be suppressed. Further, both end surfaces of the shaft 6a of the print head pressing member 6 are brought into contact with the first and second shaft stop portions 25a and 27i of the cartridge stop member 25 and the side plate 27 respectively and supported by the first bearing 1f of the chassis 1, whereby the shaft 6a of the print head pressing member 6 can be held without newly providing a separate member.

According to the first embodiment, the second shaft stop portion 27i includes the shaft pressing portion 27j elastically deformable along arrow X1 (see FIG. 12) perpendicularly to the axis of the shaft 6a and pressed by the peripheral surface of the shaft 6a close to the second end (along arrow Z in FIG. 1) thereof along arrow X1 (see FIG. 12) when the shaft 6a is mounted on the L-shaped bearing if of the chassis 1, whereby the shaft 6a can be easily mounted on the L-shaped bearing if of the chassis 1 by pressing the elastically deformable shaft pressing portion 27j of the second shaft stop portion 27i with the peripheral surface of the shaft 6a close to the second end (along arrow Z in FIG. 1) thereof.

According to the first embodiment, the second shaft stop portion 27i is provided with the contact portion 27k coming into contact with the second end surface (along arrow Z) of the shaft 6a on the position separated from the side surface of the shaft pressing portion 27j closer to the shaft 6a by the length L (see FIG. 11) outward from the shaft 6a to be continuous with the shaft pressing portion 27j so that the second end surface (along arrow Z in FIG. 1) of the shaft 6a can be brought into contact with the contact portion 27k, whereby the shaft 6a can be inhibited from slipping off the chassis 1. Therefore, the position of the shaft 6a can be reliably kept.

According to the first embodiment, the thickness of the contact portion 27k along arrow X1 (see FIG. 12) perpendicular to the axis of the shaft 6a is larger than the corresponding thickness of the second shaft stop portion 27i so that the contact area between the contact portion 27k and the second end surface (along arrow Z in FIG. 1) of the shaft 6a of the print head pressing member 6 can be increased, whereby the shaft 6a can be reliably inhibited from slipping off the chassis 1.

According to the first embodiment, the width W of the second shaft stop portion 27i in the axial direction (along arrow Z) of the shaft 6a is larger than the thicknesses (t1 and t2 in FIG. 12) along arrow X1 so that the second shaft stop portion 27i can be inhibited from deformation in the axial direction of the shaft 6a, whereby the shaft 6a can be inhibited from slipping off the chassis 1 in the axial direction, and can be reliably held as a result.

### Second Embodiment

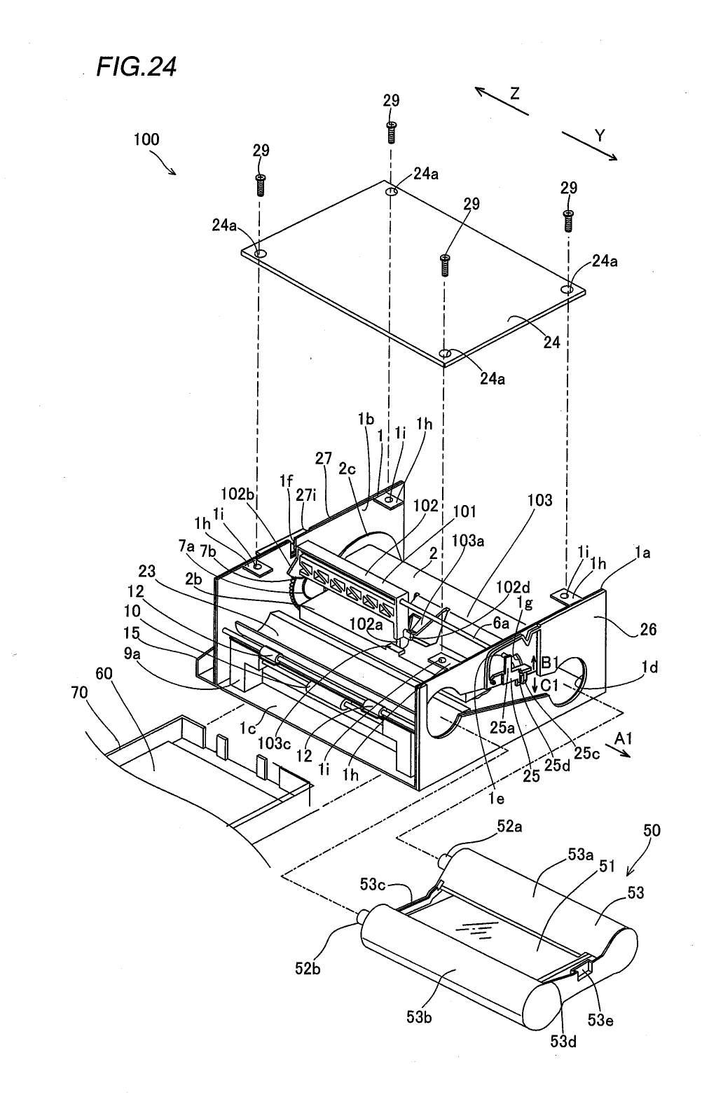

The structure of a sublimatic printer 100 according to a second embodiment of the present invention is described with reference to FIGS. 24 to 29. In the sublimatic printer 100 according to the second embodiment, a rotational portion 102 of a print head pressing member 101 is made of not metal but resin, dissimilarly to the sublimatic printer 90 according to the aforementioned first embodiment.

The sublimatic printer 100 according to the second embodiment comprises the print head pressing member 101, including a shaft 6a, pressing a print head 2, as shown in FIG. 24.

The print head 2 includes a heat radiating member 103 for radiating heat from a head portion 2b, as shown in FIG. 24.

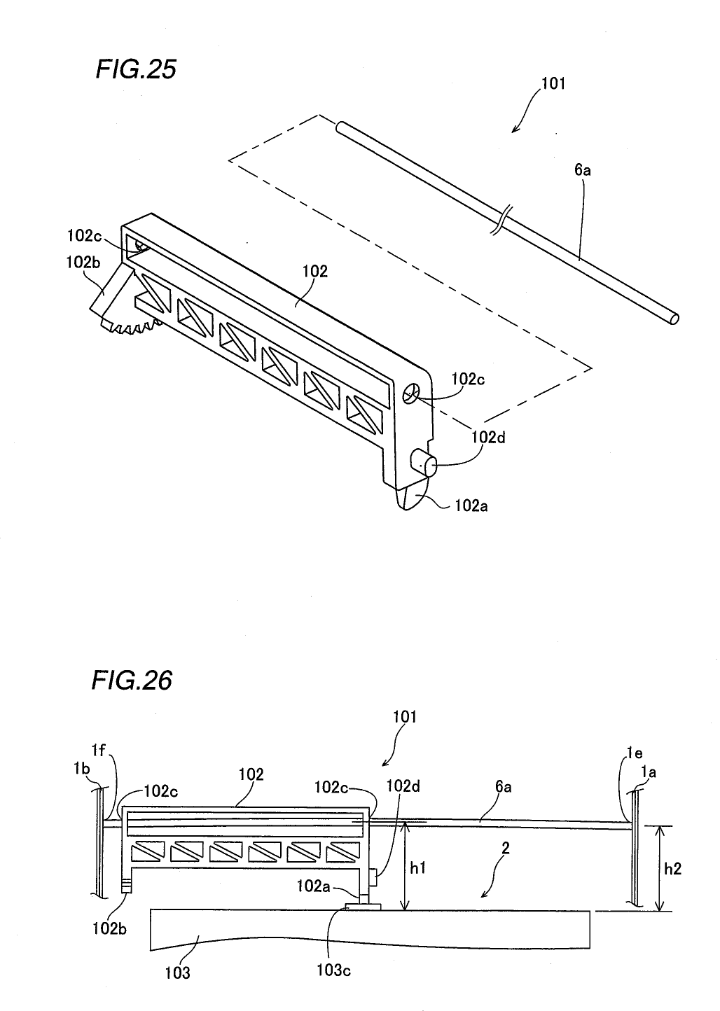

According to the second embodiment, the print head pressing member 101 is constituted of the shaft 6a of metal and the rotational portion 102 of resin, as shown in FIGS. 24 and 25. A pressing portion 102a and a sectorial gear portion 102b are integrally provided on longitudinal ends of the rotational portion 102 respectively. The print head pressing member 101 is so arranged above the print head 2 that the pressing portion 102a presses a substantially central portion of the print head 2 in the cross direction (along arrows Y and Z). Receiving holes 102c for receiving the shaft 6a are provided on both ends of the rotational portion 102 of resin respectively. The rotational portion 102 is rotatable around the shaft 6a received in the receiving holes 102c. As shown in FIG. 26, the receiving holes 102c are so formed that the distance h1 between the upper surface of the print head 2 and the receiving holes 102c is larger than the distance h2 between the upper surface of the print head 2 and support holes 1e and if for the shaft 6a provided on first and second side surfaces 1a and 1b of a chassis 1 respectively when the pressing portion 102a is in contact with the upper surface of the print head 2 in printing. Thus, the shaft 6a is so deflected as to protrude the axial center thereof upward when the pressing portion 102a is in contact with the upper surface of the print head 2 in printing, thereby pressing the print head 2 downward from above with downward restoring force of the shaft 6a through the pressing portion 102a. Consequently, the print head 2 is pressed toward the platen roller 3 in printing.

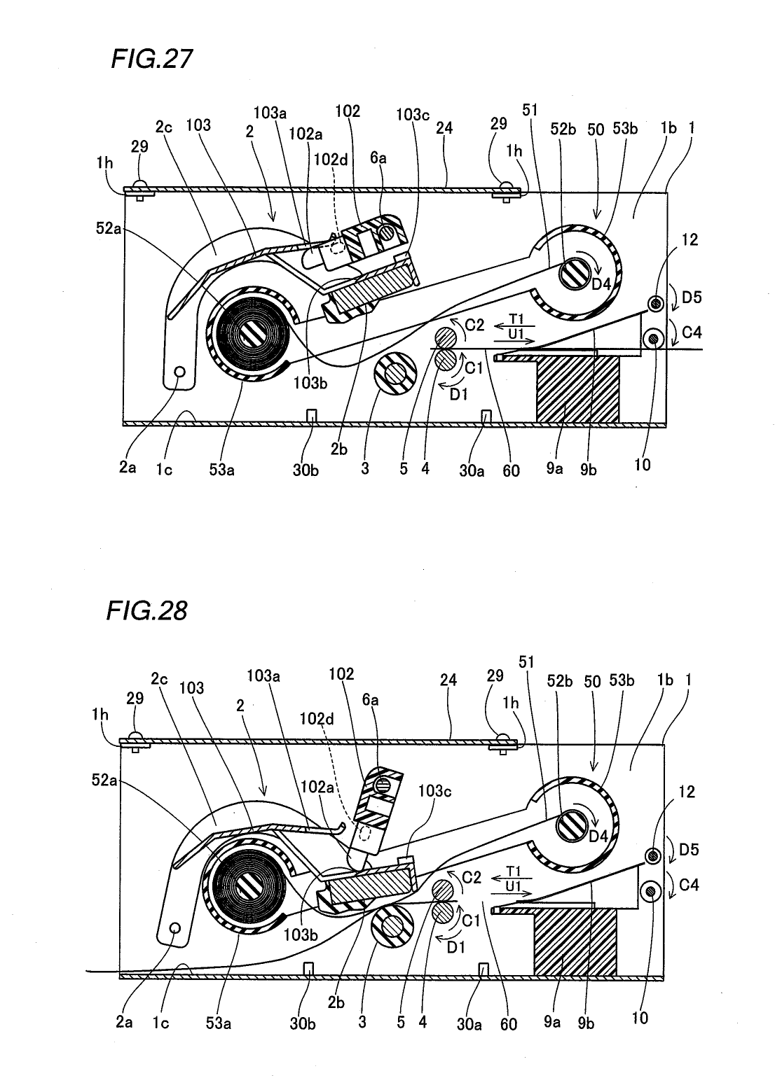

According to the second embodiment, a push-up portion 103a pushed up by a protrusion 102d provided on the rotational portion 102 upon upward rotation of the rotational portion 102 is integrally formed at the center of the heat radiating member 103 by uprighting. Thus, the push-up portion 103a of the heat radiating member 103 is pushed up by the protrusion 102d of the rotational portion 102 upon upward rotation of the rotational portion 102 thereby rotating the print head 2 in a direction for separating from the platen roller 3, as shown in FIG. 27.

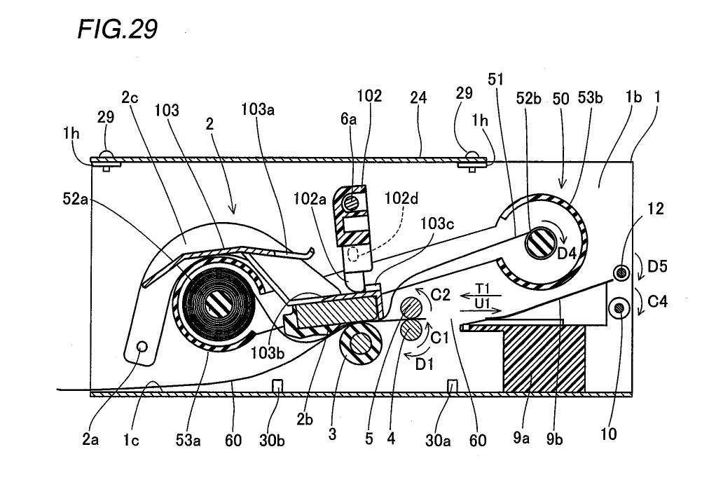

An edge 103b of an opening resulting from the uprighting for forming the push-up portion 103a is smoothly inclined in the vertical direction. Thus, the pressing portion 102a of the rotational portion 102 smoothly slides along the edge 103b upon downward rotation of the rotational portion 102 as shown in FIGS. 28 and 29, whereby the pressing portion 102a can easily move to the upper surface of the heat radiating member 103.

As shown in FIG. 29, a deviation preventing portion 103c is integrally formed on an end of the upper surface of the heat radiating member 103, in order to prevent the rotational portion 102 so rotated that the pressing portion 102a reaches the upper surface of the heat radiating member 103 from deviating in the rotational direction (along arrow F).

The remaining structure of the sublimatic printer 100 according to the second embodiment is similar to that of the aforementioned first embodiment.

According to the second embodiment, as hereinabove described, the sublimatic printer 100 is provided with the platen roller 3 opposed to the print head 2 and the heat radiating member 103 mounted on the print head 2 for radiating heat generated in the print head 2 while the heat radiating member 103 is integrally provided with the push-up portion 103a pushed up by the rotational portion 102 upon rotation of the rotational portion 102 and the rotational portion 102 pushes up the push-up portion 103a of the heat radiating member 103 upon rotation for moving the heat radiating member 103 and the print head 2 in the direction for separating from the platen roller 3 so that the rotational portion 102 pushes up the push-up portion 103a upon rotation thereof, whereby the heat radiating member 103 and the print head 2 can be easily rotated in the direction for separating from the platen roller 3 with no requirement for a transmission mechanism so provided as to transmit the rotational force of the rotational portion 102 to the heat radiating member 103 and the print head 2. Consequently, increase in the number of components can be further suppressed.

According to the second embodiment, the rotational portion 102 presses the print head 2 toward the platen roller 3 in printing while the heat radiating member 103 is provided with the deviation preventing portion 103c preventing the rotational portion 102 from deviating in the rotational direction when the rotational portion 102 presses the print head 2 toward the platen roller 3 in printing so that the rotational portion 102 does not deviate in the rotational direction in printing, thereby reliably pressing the print head 2 toward the platen roller 3.

According to the second embodiment, the body of the rotational portion 102 is made of resin, whereby noise caused in the rotational portion 102 when sliding with the shaft 6a of metal upon rotation can be suppressed as compared with a case where the rotational portion 102 is made of metal.

The remaining effects of the second embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while each of the aforementioned first and second embodiments is applied to the sublimatic printer employed as an exemplary image generating apparatus, the present invention is not restricted to this but is also applicable to an image generating apparatus other than the sublimatic printer, so far as the same has a print head pressing member pressing a print head.

While the thickness t1 of the contact portion of the second shaft stop portion along arrow X1 (see FIG. 12) is larger than the corresponding thickness t2 (see FIG. 12) of the second shaft stop portion in each of the aforementioned first and second embodiments, the present invention is not restricted but the thickness (t1 in FIG. 12) of the contact portion and the corresponding thickness (t2 in FIG. 12) of the second shaft stop portion may alternatively be equalized to each other so far as the shaft pressing portion of the shaft stop portion is elastically deformable along arrow X1.

What is claimed is:

1. An image generating apparatus comprising:
a chassis detachably mounted with an ink sheet cartridge storing an ink sheet and integrally provided with a first bearing;
a print head rotatably mounted on said chassis;
a print head pressing member, including a shaft held by said first bearing, pressing said print head;
a cartridge stop member provided on a first side surface of said chassis for engaging with said ink sheet cartridge thereby preventing said ink sheet cartridge from slipping off said chassis; and
a side plate, provided on a second side surface of said chassis, integrally including at least a second bearing of a paper feed roller, wherein
said cartridge stop member provided on said first side surface of said chassis integrally includes a first shaft stop portion coming into contact with a first end surface of said shaft of said print head pressing member, and
said side plate provided on said second side surface of said chassis integrally includes a second shaft stop portion coming into contact with a second end surface of said shaft of said print head pressing member.

2. The image generating apparatus according to claim 1, wherein
said second shaft stop portion includes a shaft pressing portion elastically deformable in a first direction intersecting with the axis of said shaft and pressed in said first direction by a peripheral surface of said shaft close to a second end thereof when said shaft is mounted on said first bearing of said chassis.

3. The image generating apparatus according to claim 1, wherein
said first bearing of said chassis is constituted of an L-shaped notch, and
said second shaft stop portion of said side plate further includes a contact portion provided on a position separated from a side surface of said shaft pressing portion closer to said shaft by a prescribed length outwardly from said shaft to be continuous with said shaft pressing portion for coming into contact with said second end surface of said shaft.

4. The image generating apparatus according to claim 3, wherein
the thickness of said contact portion of said second shaft stop portion in said first direction intersecting with the axis of said shaft is larger than the corresponding thickness of said second shaft stop portion.

5. The image generating apparatus according to claim 1, wherein
said second shaft stop portion is so formed that the width in the axial direction of said shaft is larger than the thickness in a direction intersecting with the axis of said shaft.

6. The image generating apparatus according to claim 1, wherein
said first bearing includes an L-shaped notch having a vertically extending first portion and a second portion horizontally extending from said first portion,
for holding said shaft in the vicinity of the forward end of said second portion of said L-shaped notch.

7. The image generating apparatus according to claim 1, further comprising:
a platen roller opposed to said print head, and
a heat radiating member mounted on said print head for radiating heat generated in said print head, wherein
said heat radiating member is integrally provided with a push-up portion pushed up by said print head pressing member upon rotation of said print head pressing member, and
said print head pressing member so pushes up said push-up portion of said heat radiating member upon rotation of said print head pressing member as to move said heat radiating member and said print head in a direction for separating from said platen roller.

8. The image generating apparatus according to claim 7, wherein
said print head pressing member presses said print head toward said platen roller in printing, and
said heat radiating member includes a deviation preventing portion preventing said print head pressing member from deviating in the rotational direction when said print head pressing member presses said print head toward said platen roller in printing.

9. The image generating apparatus according to claim 1, wherein
the body of said print head pressing member is made of resin.

10. An image generating apparatus comprising:
a chassis detachably mounted with an ink sheet cartridge storing an ink sheet;
a print head rotatably mounted on said chassis;
a first bearing, integrally provided on said chassis, constituted of an L-shaped notch;
a print head pressing member, including a shaft held by said first bearing, pressing said print head;
a cartridge stop member provided on a first side surface of said chassis for engaging with said ink sheet cartridge thereby preventing said ink sheet cartridge from slipping off said chassis; and
a side plate, provided on a second side surface of said chassis, integrally including at least a second bearing of a paper feed roller, wherein
said cartridge stop member provided on said first side surface of said chassis integrally includes a first shaft stop portion coming into contact with a first end surface of said shaft of said print head pressing member,
said side plate provided on said second side surface of said chassis integrally includes a second shaft stop portion coming into contact with a second end surface of said shaft of said print head pressing member,
said second shaft stop portion includes a shaft pressing portion elastically deformable in a first direction intersecting with the axis of said shaft and pressed in said first direction by a peripheral surface of said shaft close to a second end thereof when said shaft is mounted on said first bearing of said chassis,
said second shaft stop portion of said side plate further includes a contact portion provided on a position separated from a side surface of said shaft pressing portion closer to said shaft by a prescribed length outwardly from said shaft to be continuous with said shaft pressing portion for coming into contact with said second end surface of said shaft, and
the thickness of said contact portion of said second shaft stop portion in said first direction intersecting with the axis of said shaft is larger than the corresponding thickness of said second shaft stop portion.

11. The image generating apparatus according to claim 10, wherein
said second shaft stop portion is so formed that the width in the axial direction of said shaft is larger than the width in said first direction intersecting with the axis of said shaft.

12. The image generating apparatus according to claim 10, wherein
said first bearing includes said L-shaped notch having a vertically extending first portion and a second portion horizontally extending from said first portion,
for holding said shaft in the vicinity of the forward end of said second portion of said L-shaped notch.

13. The image generating apparatus according to claim 10, further comprising:
a platen roller opposed to said print head, and
a heat radiating member mounted on said print head for radiating heat generated in said print head, wherein
said heat radiating member is integrally provided with a push-up portion pushed up by said print head pressing member upon rotation of said print head pressing member, and
said print head pressing member so pushes up said push-up portion of said heat radiating member upon rotation of said print head pressing member as to move said heat radiating member and said print head in a direction for separating from said platen roller.

14. The image generating apparatus according to claim 13, wherein
said print head pressing member presses said print head toward said platen roller in printing, and
said heat radiating member includes a deviation preventing portion preventing said print head pressing member from deviating in the rotational direction when said print head pressing member presses said print head toward said platen roller in printing.

15. The image generating apparatus according to claim 10, wherein
the body of said print head pressing member is made of resin.
